(19) United States
(12) Patent Application Publication
(10) Pub. No.: US 2019/0283084 A1
(43) Pub. Date: Sep. 19, 2019

(54) STATICALLY WEIGHED GRADING APPARATUS AND METHOD

(71) Applicant: Baader Linco, Inc., Kansas City, KS (US)

(72) Inventor: Ryan John FOLTZ, Bucyrus, KS (US)

(21) Appl. No.: 16/351,121

(22) Filed: Mar. 12, 2019

Related U.S. Application Data
(60) Provisional application No. 62/642,573, filed on Mar. 13, 2018.

(51) Int. Cl. B07C 5/18; B07C 5/38; A22C 17/00

(52) U.S. Cl. CPC B07C 5/18; A22C 17/0093; B07C 5/38

(57) ABSTRACT

A statically weighed grading apparatus and method includes a static weight sensing apparatus weighing food parts prior to distribution to batches of food parts. The food parts are moved to batches to accumulate batches of parts having the same weight for each part, or batches of similar parts to achieve a desired total batch weight. Food parts are precisely deposited on a movement device to increase the density of food parts on the movement device maximizing throughput of the system. Several food parts can be transferred to the movement device to comprise a sub-batch prior to transfer to a final batch.

### CROSS-REFERENCE TO RELATED APPLICATIONS

This application claims priority in U.S. Provisional Patent Application Ser. No. 62/642,573, filed Mar. 13, 2018, the contents of which are hereby incorporated by reference.

### BACKGROUND

### 1. Field of the Disclosed Subject Matter

The present disclosed subject matter relates to food processing, and in particular, statically weighed grading of food items of varying sizes, including harvested animal food parts.

### 2. Background

Processing of food items for consumption may result in food items, and pieces or parts thereof, having varying weight and size. Food pieces are often gathered and graded, traveling in lanes down a conveyor belt, prior to undergoing further processing or distribution to a customer. This process is often accomplished by what is known in the industry as a grader, which is a device that individually weighs and sorts product based on those weights, and as desired, other additional information about or characteristics of the product. The product is sorted or graded based on the desired criteria of the individual pieces and the final batch, such as weight, or any additional information as desired.

Grading includes the steps of weighing and sorting food pieces. Grading each food item and food piece allows an operator to create batches of food items and food pieces that meet customer specifications. Current apparatuses and methods grading animal food parts into batches limits processing to approximately 200 pieces per minute per lane of grading.

### SUMMARY

A statically weighed grading apparatus and method includes a static weight sensing apparatus for receiving, statically weighing, and transferring a food part to a movement device. The weight sensing apparatus generates weight data associated with the food part. The movement device receives the weighed food part and transports the weighed food part to a batch sorting zone where the food part is transferred to its intended batch. In an implementation, a grading sensor generates grading data associated with the weighed food part. A computer receives the weight data and the grading data. The computer is adapted to operably control the weight sensing apparatus and movement device, and the computer controls transfer of the weighed food part from the weight sensing apparatus to the movement device, and the movement device as it moves the weighed food part to an intended batch.

In an implementation, the computer is adapted to densely distribute the weighed food parts on the movement device. In an implementation, the apparatus can be deployed with one or more weight sensing apparatus adjacent the movement device, with the weight sensing apparatuses densely distributing the food parts on the movement device. In an implementation, the food parts are separated from food parts on the movement device between and including 0.01 mm and 30 mm, in particular between and including 0.1 mm and 20 mm, more particularly between and including 0.1 mm and 10 mm, and preferably between and including 1 mm and 5 mm. In an implementation, hoppers are used for receiving and transferring the food parts. For example, a pre-hopper for receiving a food part and for transferring the food part to the weight sensing apparatus may be used. In an implementation, the computer operably controls the pre-hopper and a post-hopper, and the computer controls the transfer of the food part from the pre-hopper and the post-hopper. In an implementation, an ejector, controlled by the computer, transfers the weighed food part from the movement device to a batch. In an implementation, a post-hopper receives a food part from a weight sensing apparatus, and transfers the food part from the post-hopper to the movement device.

A method of statically weighed grading includes providing a weight sensing apparatus for processing a plurality of food parts. The weight sensing apparatus weighs each food part and transfers each food part to a movement device or a post-hopper. The movement device transfers the food parts to a sorting device for transferring each food part from the movement device to a batch within a container.

In an implementation, one or more weight sensing apparatuses are used and they sequentially transfer each food part from the weight sensing apparatus to the movement device spacing the food parts on the movement device. In an implementation, the weight sensing apparatuses are stationary with respect to the movement device. In an implementation, a pre-hopper is used to transfer food parts to the weight sensing apparatus, allowing the pacing of the rate the weight sensing apparatus transfers food parts to the movement device. In an implementation, a post-hopper receives weighed food parts form the weight sensing apparatus and the post-hopper is used to transfer food parts to the movement device, allowing the pacing of the rate of transferring weighed food parts to the movement device. In an implementation, each weight sensing apparatus is assigned to handle a food part with specified characteristics. In an implementation, each weight sensing apparatus generates weight data associated with each food part, and the weight data is used to calculate the rate of transfer of each food part from the weight sensing apparatus to the movement device. This performance data is used to adjust the rate of transfer of each food part from the weight sensing apparatus to the movement device to maximize the rate of processing food parts and the weight sensing apparatus's performance.

### BRIEF DESCRIPTION OF THE DRAWINGS

The present disclosed subject matter is described herein with reference to the following drawing figures, with greater emphasis being placed on clarity rather than scale.

FIG. 1 is an elevation view showing aspects of the statically weighed grading apparatus and method of the disclosed subject matter.

FIG. 2 is a schematic representation of an implementation of the weight sensing apparatus and a movement device.

FIG. 3 is a schematic representation of an alternative embodiment of the weight sensing apparatus and movement device.

### DETAILED DESCRIPTION

The disclosed subject matter pertains to a food processing apparatus and method 100, in particular, statically weighing food prior to transportation of the food along a conveyor for sorting into batches. Food includes any substance providing nutritional support for an animal, such as humans. Food includes an entire plant or animals, any part thereof, or processed food, including cheese and candy bars. Batch criteria includes type of food, food part, weight of each food part, grade of food part, quantity of food parts, overall batch weight, and batches with food parts having a known weight range.

The types of animals yielding animal parts include, but are not limited to fish, crustacean, beef, pork, and poultry. Typically one type of animal is processed at a time, and the disclosed processing apparatus and method performs weighing, transfer, and sorting for one or more animal parts. For example, the type of animal is poultry, and the animal parts processed as food parts 102 include tenders, wings, legs, bone-in thighs, or breasts.

An embodiment of the disclosed subject matter includes the steps of statically weighing a food part 102, followed by transferring the weighed food part 102 to a movement device 120, the movement device 120 moving the food part 102 from a weight sensing apparatus 104 to a batch sorting zone 126, and then transferring the weighed food part 102 from the movement device 120 to a batch 130 of one or more food parts. In an embodiment, the disclosed subject matter includes the step of grading the food part 102 following the step of weighing the food part 102. In an embodiment, the steps and associated apparatuses are controlled by a computing device adapted to control the steps and associated apparatuses, such as a programmable logic computer (PLC) 110.

In an embodiment, the step of statically weighing the food part 102 occurs when the food part 102 and a weight sensing apparatus 104 are not moving or are static, such as weighing a food part 102 on a stationary plate 106 in a weighing hopper, where the plate 106 is operably connected to a weight sensor 108. Therefore the weight sensing apparatus 104 is static or not moving relative to a movement device 120. Static weighing increases the accuracy of the weight data associated with the food part 102 by removing dynamic forces that affect the accuracy of the resulting weight data, such as found in in-motion weight scales used in conventional belt driven weight graders and sorters. The weight sensing apparatus 104 senses, ascertains, or determines the weight of the food part 102. Weighing the food part 102 when it is not moving or it is static results in more accurate weight measurements, thereby increasing the accuracy of the resulting batch weight, resulting in less giveaway of product weight above the specified weight for a batch. In the alternative, weighing the food part 102 while the food part 102 is moving, such as weighing the part 102 on a conveyor belt as the belt moves across a weight deck, requires the resulting measurement to compensate for factors that affect the accuracy of the determined weight, including movement of the part 102 on the belt, and weighing while moving imposes limitations on the speed at which the food part 102 can be moved to an intended batch.

An embodiment includes the step of transferring a food part 102 from a pre-hopper 112 to the weight sensing apparatus 104. Food parts 102 arrive at the pre-hopper 112 or weight sensing apparatus 104 from pre-processing. In an embodiment, animal food parts 102 arrive at the pre-hopper 112 from a source, such as a cut-up line where an animal is processed by harvesting the desired tissues from the animal resulting in parts 102, such as the harvesting of poultry tenders, bone-in thighs, or breast meat. The animal food parts 102 may arrive frozen, from a quick freezing tunnel or spiral conveyor freezer, or the parts 102 arrive soft and sticky, freshly harvested from the animal. In an implementation, food parts 102 first encounter the weight sensing apparatus 104 upon arriving from a source, such as the cut-up line, followed by a transfer to a post-hopper, similar to the pre-hopper 112, where the food parts 102 are held until the PLC 110 determines when to transfer the part from one or more post-hoppers to an unoccupied location 128 or an occupied location on the movement device 120.

An embodiment includes a plurality of adjacent weight sensing apparatuses 104 arranged adjacent a movement device 120 thereby allowing the food parts 102 to be positioned precisely on the movement device 120 with minimal spacing between food parts 102. In an embodiment, the PLC 110 is programmed with the largest expected size for a food part 102 weighed by a weight sensing apparatus 104, and the PLC 110 uses the largest expected size information to determine the minimum spacing between food parts 102 on the movement device 120, detect and determine if more than one food part 102 is on a given weight sensing apparatus 104, and control operation of the weight sensing apparatus 104 to distribute weighed food parts 102 on the movement device 120. In an embodiment, minimal spacing between food parts 102 results in the parts 102 distributed on the loaded movement device 120 wherein the center to center distance between adjacent food parts 102 can be as small as the largest expected piece resulting in the food parts 102 being densely packed on the movement device 120, thereby maximizing throughput of the system. In an embodiment, the spacing between the edge of food parts 102 on the movement device 120 is equal to or greater than 0.01 mm. In an implementation, the edges of food parts are separated from adjacent food parts on the movement device between and including 0.01 mm and 30 mm, in particular between and including 0.1 mm and 20 mm, more particularly between and including 0.1 mm and 10 mm, and preferably between and including 1 mm and 5 mm.

If more than one food part 102 is on the weight sensing apparatus 104, the contents of the apparatus 104 are not transferred to the movement device 120 and are re-run through the system so that one food part 102 is weighed by a weight sensing apparatus 104 at a time.

In an embodiment, the food part 102 is transferred to the pre-hopper 112 or weight sensing apparatus 104 manually by an operator, by dropping, or by a mechanical device, such as a diverter. The PLC 110 is adapted to control operation of the pre-hopper 112 and weight sensing apparatus 104, and the PLC 110 determines at what time in the processing sequence to transfer a food part 102 from the pre-hopper 112 to the weight sensing apparatus 104, at what time to transfer a part 102 from the weight sensing apparatus 104 to the movement device 120, or at what time to transfer the part 102 from the weight sensing apparatus 104 to a post-hopper, and from the post-hopper to the movement device 120. The PLC 110 is programmed to transfer a food part 102 to a target weight sensing apparatus 104 when the target weight sensing apparatus 104 is vacant thereby allowing the apparatus 104 to weigh one food part 102 at a time. The PLC 110 is programmed to transfer a food part 102 from the target weight sensing apparatus 104 to an unoccupied 128 or vacant location on the movement device 120 when the movement device 120 has an unoccupied location 128. In an embodiment, the PLC 110 is programmed to transfer a food part 102 from a weight sensing apparatus 104 to a post-hopper, and from the post-hopper to an unoccupied location 128. In an implementation, the food parts 102 are transferred sequentially to the movement device 120. Alternatively, when the system is forming sub-batches 146 on the movement device 120, the PLC 110 is programmed to transfer a food part 102 onto an occupied location on the device 120.

The PLC 110 identifies, or is programmed to determine, the type of food part 102 associated with each pre-hopper 112, weight sensing apparatus 104 and post-hopper, and the PLC 110 tracks the location of each food part 102 on the movement device 120. For example, four weight sensing apparatuses 104 may be arranged adjacent a movement device 120, where two of the apparatus 104 are used for a first type of food part 102, and the remaining two apparatuses 104 are used for a second type of food part 102. Additionally, the PLC 110 can be programmed to associate an expected weight range for a food part 102 and detect if a weight sensing apparatus 104 includes more than one of the food parts 102. The PLC 110 can transfer the food parts 102 to be reloaded separately before the parts 102 are transferred to the movement device 120 for further processing.

Following the static weighing step, the PLC 110 is adapted to transfer the weighed food part 102 to a movement device 120, such as a moving belt 122 moved by a motor 121, where the food part moves to a sorting zone 126. The system can include a plurality of weight sensing apparatuses 104 positioned adjacent a movement device 120. The weight sensing apparatus 104 or the post-hopper transfers the weighed food part 102 onto a specified location on the movement device 120, such as an unoccupied location 128 available to receive a food part 102 or an occupied location to create sub-batches 146. The PLC 110 calculates the rate of transfer of each food part 102 from each weight sensing apparatus 104 to the movement device 120. The rate of transfer is used by the PLC 110 to assess the performance of the weight sensing apparatus 104, allowing for the PLC 110 or an operator to adjust the rate the apparatus 104 transfers parts 102 to the movement device 120 to maximize each apparatus's 104 efficiency. In an embodiment, a PLC 110 tracks unoccupied locations 128 on the movement device 120 and determines and controls when each weight sensing apparatus 104 or each post-hopper transfers its weighed food part 102 onto the movement device 120, minimizing the spacing between each food part 102 thereby maximizing the number of food parts 102 on the movement device 120.

Food parts 102 of the same type, such as harvested animal food parts, can have varying characteristics that influence their positioning and movement relative to the movement device 120 when they come in contact with the movement device 120, such as the weight of the food part 102, size of the part 102, the shape of the part 102, and if the part 102 is fresh (soft and sticky) or frozen (hard, bouncy, and tippy). In an embodiment, fresh food parts and frozen food parts include poultry parts.

In an implementation, two or more parts 102 are transferred to the movement device 120 from the weight sensing apparatus 104 or post-hopper and accumulate on the movement device 120, accumulating in a sub-batch 146 in an area on the movement device 120. For example, the sub-batch 146 may comprise three food parts 102 of the same or similar weights. The sub-batch 146 is moved by the movement device 120 to the sorting zone 126 for transfer to an intended batch 130 to either comprise the complete batch, or to add to an existing batch 130.

The speed of the movement device 120 relative to a weight sensing apparatus 104 can be varied to minimize movement of the food part 102 on the movement device 120 when the part 102 is transferred to the movement device 120, and can be varied to dictate the food parts 102 per unit of time that pass through the grading zone 124 and sorting or batch transfer zone 126. The PLC 110 is adapted to operably control the speed of the movement device 120. In an implementation, the weight sensing apparatus 104 is operably controlled by the PLC 110 to accelerate the statically weighed food part 102 upon transfer to the movement device 120 to match, or closely match the speed of the movement device 120, thereby accommodating for the characteristics of the food part 102 to dictate the positioning and movement of the food part 102 relative to the movement device, and the location of the food part 102 on the movement device 120.

In an embodiment, a first and a second movement device 120 are used when transporting food parts 102 that are difficult to accelerate, such as hard, bouncy, tippy, or slippery food parts 102. The first movement device 120 is controlled to move slowly when receiving food parts 102 from one or more weight sensing apparatus 104 to create minimal spacing between the parts 102 and to minimize movement of the parts 102 as they come to rest on the movement device 120. The food parts 102 move to the second movement device 120, controlled to move at a faster rate than the first movement device 120, where the parts 102 are accelerated to move more quickly. In an embodiment, a single movement device 120 is used for food parts 102 that are less difficult to accelerate, such as soft or sticky food parts 102, and the food parts 102 have minimal spacing between parts 102. In another embodiment, the food parts 102 are moved quickly by the movement device 120 and the spacing between the parts 102 is increased as the parts 102 pass through the batch sorting zone 126.

In an embodiment, a plurality of adjacent weight sensing apparatuses 104 arranged adjacent a movement device 120 maximizes the number of food parts 102 on the movement device 120 and minimizes unused space on the movement device 120. This improves part 102 throughput over conventional in-motion weight sensing by reducing the number of operators manually loading food parts 102 into a the pre-hopper 112 or directly into a weight sensing apparatus 104, distributing the workload more evenly, and eliminates a need for a device that increases the spacing between the parts 102 after they are transferred to the movement device 120, further reducing the physical footprint of the processing apparatus.

Further, the PLC 110 tracks the weight and location of the food part 102 on the movement device 120 and associates grading characteristics or information with each food part 102 as the part moves through the grading zone 124. The weight, location, and grade of the food part 102 allows the PLC 110 to determine and control the batch destination in the batch sorting zone 126 for each food part 102 according to pre-programmed intended sorting criteria.

The grading step includes the sensing, ascertaining, or determination of the food part 102 location on the movement device 120, part 102 orientation on the movement device 120, the geometry of the part 102, such as the height, length, and width, and the leading edge and trailing edge of the part 102. The sensing, ascertaining, or determining is accomplished by a grading sensor 125 operably connected to the PLC 110, such as an optical sensor that images the part 102 from one or more positions including above, below, and/or adjacent the movement device 120. The PLC 110 gathers the grading data to reliably and precisely determine the location of the food part 102 on the movement device 120, such as to confirm the actual location of the part 102 after the part 102 has transferred from the weight sensing apparatus 104 to the movement device 120, and determines the destination for each part 102 according to pre-programmed criteria. In an embodiment, the sensor 125 detects the absence or presence of a food part 102 on the movement device 120, and confirms the actual location of the food part 102 on the movement device 120 after the movement device 120 has been accelerated to operating speed. Reliable and precise determination of the food part 102 on the movement device 120 allows the system to accurately direct the part 102 to the appropriate batch 130.

Following the grading step, the food parts 102 enter the batch transfer step. As the food parts 102 enter the batch sorting zone 126, the PLC 110 has associated or determined the location of each part 102 on the movement device 120, and the weight and grading characteristics of each part 102. The food parts 102 are moved from the movement device 120 to the desired batch 130 by a product ejector 134 operably controlled by the PLC 110. The count of food parts 102 in each batch 130 and the total weight of each batch 130 is tracked by the PLC 110 and the batch 130 moves to further processing when the pre-programmed criteria is met for a batch 130. The batch 130 weight may be determined by a weight sensor 108. The batches 130 can be collected in a container, including a tray, bag, or bin 131.

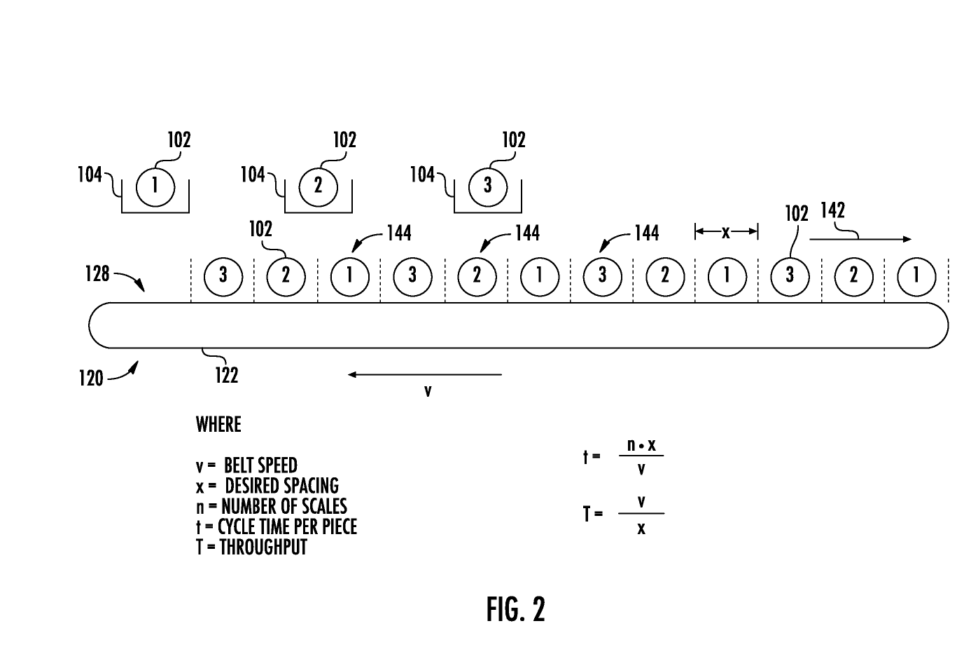

Referring to FIG. 2, an implementation of weight sensing apparatuses 104 and a movement device 120 includes a plurality of weigh sensing apparatuses 104 separated by a separation distance and disposed adjacent a movement device 120. For example, the first and second weight sensing apparatuses 104 shown in FIG. 2 are separated by a desired separation distance, and the second and third weight sensing apparatuses 104 are separated by the same desired separation distance. In an implementation, controlled by the PLC 110, the first, second, and third weight sensing apparatuses 104 simultaneously, in unison, transfer their contents, such as food parts 102, to the movement device 120, represented by a conveyor belt 122, such as by dropping the contents onto the conveyor belt 122. The contents of the first and second weight sensing apparatuses 104 would be separated by the desired separation distance on the conveyor belt 122, and the contents of the second and third weight sensing apparatuses 104 would be separated by the desired separation distance on the conveyor belt 122. For example, the contents of the first, second, and third weight sensing apparatuses 104 would deposit their contents on the conveyor belt 122 according to the shown desired food part placement 144. Controlled by the PLC 110, the conveyor would continue to move in the direction of arrow 142 whereby the transferred contents would move away from the first, second, and third weight sensing apparatuses 104, and unoccupied locations of the conveyor belt 122 would be available to the first, second, and third weight sensing apparatuses 104 permitting the PLC 110 to operably control the weight sensing apparatuses 104 to transfer the contents of the apparatuses 104 to the conveyor belt 122. Separating weight sensing apparatuses 104 adjacent a movement device 120 with a fixed separation distance between weight sensing apparatuses 104 allows the contents to be densely distributed on the movement device 120.

In another implementation, weight sensing apparatuses 104 are disposed adjacent a movement device 120, and the PLC 110 operably controls the weight sensing apparatuses 104, and post-hopper whereby the PLC 110 ascertains or determines the timing of the transfer of the contents of each weight sensing apparatus 104 or post-hopper to unoccupied locations 128 or occupied locations on the movement device. For example, the PLC 110 times the transfer of the contents, such as food parts 102, to be placed at unoccupied locations 128 on the movement device, such as a conveyor belt 122. In an implementation, the PLC 110 times the drops sequentially to fully populate the conveyor belt with minimal unused belt space between the food parts 102. In an implementation, as the conveyor belt 122 passes the weight sensing apparatuses 104 or post-hopper, each successive weight sensing apparatus 104 or post-hopper would be controlled to transfer its food part 102 to the conveyor belt 122 the desired separation distance behind the preceding food part 102.

The total cycle time for each weight sensing apparatus 104, and the maximum number of food parts 102 processed by the system, known as throughput, would be determined by a combination of the speed of the movement device 120, the number of weight sensing apparatuses 104 transferring food parts 102 to the movement device 120, and the selected desired separation distance between food parts 102 on the movement device 120. Referring to FIG. 2, Throughput (T) can be calculated by dividing the speed of the movement device 120 (v) by the desired spacing (x). For example, throughput (T) equals the belt speed of the conveyor (v) divided by the desired spacing (x). The cycle time per food part 102 (t) can be calculated by multiplying the number of weight sensing apparatuses 104 (n) by the desired spacing (x) and dividing by the speed of the movement device 120 (v). For example, cycle time per piece of food part 102 (t) equals the number of weight sensing apparatuses 104 (n) multiplied by the desired spacing (x), and dividing the result by the speed of the movement device 120 (v). The presently disclosed processing apparatus and method 100, in particular, statically weighing food prior to transportation of the food along a conveyor for sorting into batches, allows the food parts 102 to be transferred to the movement device 120 or conveyor belt whereby utilization of the space on the conveyor belt is maximized by minimizing the distance between food parts 102 that are on the conveyor belt, thereby maximizing throughput of the system at any speed of the conveyor (v).

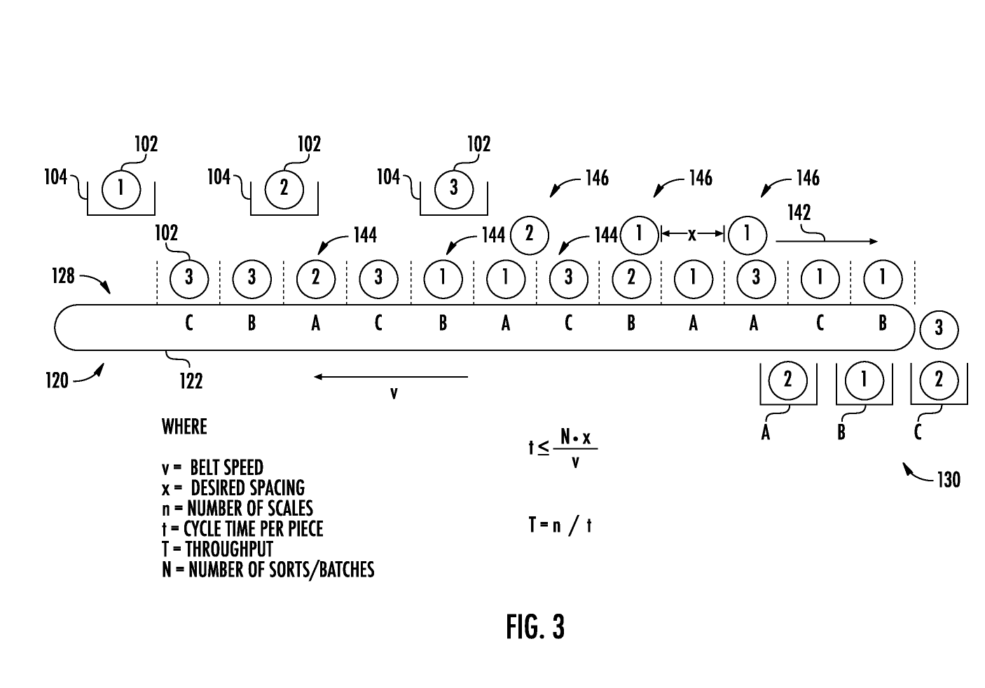

Referring to FIG. 3, in an embodiment of the weight sensing apparatuses 104 and movement device 120 a plurality of food parts 102 are transferred to the movement device 120 whereby individual food parts 102 are each transferred to a location on the movement device 120, or an assortment of food parts 102 are deposited at a single location on the movement device 120 forming sub-batches 146. The individual food parts 102 and sub-batches 146 are used to create the batches 130.

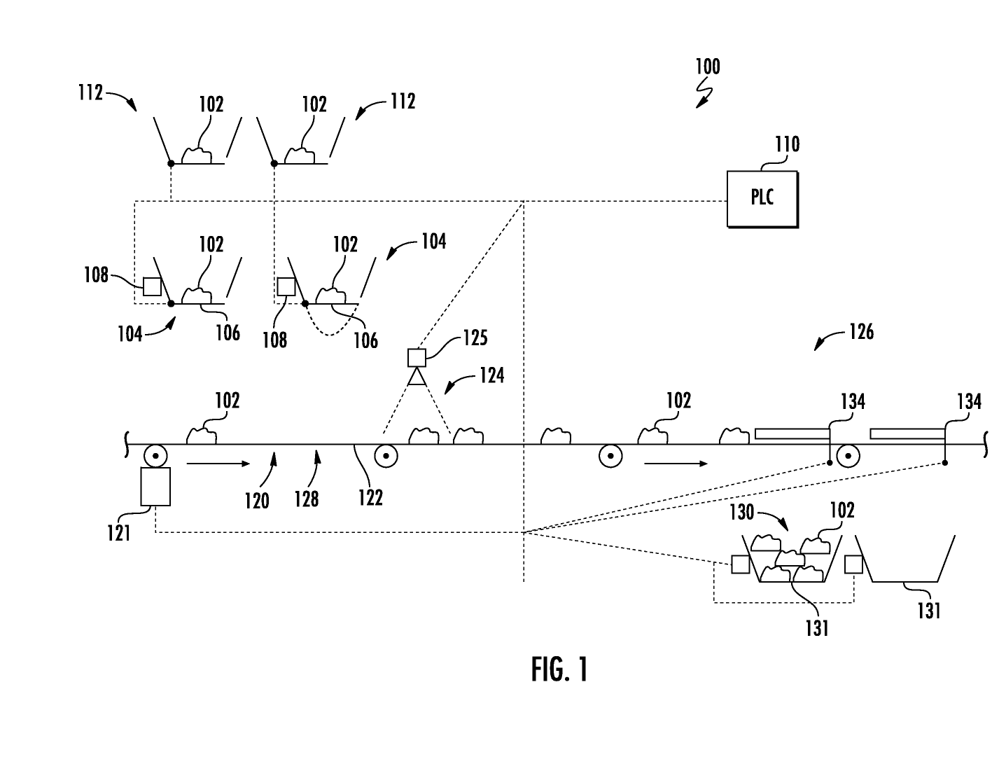

The PLC 110 determines the food part 102 characteristic, such as food part 102 weight, and location on the movement device 120 to deposit the food parts 102. In the implementation shown in FIG. 3, the food parts 102 are transferred from the weight sensing apparatus 104 to the movement device 120. Alternatively, the food parts 102 are transferred to the movement device 120 by a post-hopper, as described above. The PLC 110 assigns a batch target location for each location on the movement device 120 corresponding to the target batch. For example, moving from left to right along the movement device 120 in FIG. 3, an unoccupied location 128 is adjacent an occupied location identified as C containing food part 102 identified as originating from the weight sensing apparatus 104 dispensing parts identified as 3, which is adjacent an occupied location identified as B containing food part 102 identified as originating from the weight sensing apparatus 104 dispensing parts identified as 3. The occupied locations of the movement device 120 are identified by A, B, or C on the movement device 120 corresponding to the batch 130 destination identified with the same letter (A, B, or C), thereby allowing system to create batches 130 based on the characteristic of the available population of food parts 102 being processed. The PLC 110 then controls movement of the individual food parts 102 and the sub-batches 146 to the desired target batch 130. For example, when accumulating food parts 102 to achieve a desired batch 130 consisting of a plurality of food parts 102 that have a particular characteristic, such as a batch 130 having a desired total weight, or a batch 130 comprising a plurality of food parts 102 that each have a weight that falls within a range, the PLC 110 can deposit individual food parts 102 on the movement device 120 and create sub-batches 146 on the movement device 120 to deliver the desired food parts 102 to the desired batch 130. The individual food parts 102 or sub-batches 146 desired for a particular target batch 130 are moved from the movement device 120 to the desired batch 130, for example, by a product ejector operably controlled by the PLC 110, such as the product ejector 134 of FIG. 1.

The total cycle time for each weight sensing apparatus 104, and the maximum number of food parts 102 processed by the system shown in FIG. 3, known as throughput, would be determined by a combination of the speed of the movement device 120, the number of weight sensing apparatuses 104 transferring food parts 102 to the movement device 120, the selected desired separation distance between food parts 102 on the movement device 120, and the number of sorts or batches 130 (N). Referring to FIG. 3, Throughput (T) can be calculated by dividing the number of weight sensing apparatuses 104 or scales (n) by the cycle time per food part 102 (t). For example, throughput (T) equals the number of scales (n) divided by the cycle time per food part 102 (t). The cycle time per food part 102 (t) can be calculated by multiplying the number of sorts or batches 130 (N) by the desired spacing (x) and dividing by the speed of the movement device 120 (v). For example, cycle time per piece of food part 102 (t) is less than or equal to the number of sorts or batches 130 (N) by the desired spacing (x) and dividing the speed of the movement device 120 (v).

As required, detailed aspects of the present disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims, and as a representative basis for teaching one skilled in the art to variously employ the present disclosed subject matter in virtually any appropriately detailed structure.

The many features and advantages of the disclosed subject matter are apparent from the detailed specification. Further, since numerous modifications and variations will readily occur to those skilled in the art, it is not desired to limit the disclosed subject matter to the exact construction and operation illustrated and described. Accordingly, all suitable modifications and equivalents may be resorted to, and all fall within the scope of the disclosed subject matter

Having described the disclosed subject matter, what is claimed as new and desired to be secured by Letters Patent is:

1. An apparatus, comprising:
a static weight sensing apparatus for receiving, weighing, and transferring a food part to a movement device;
wherein the static weight sensing apparatus generates weight data associated with the food part;
wherein the movement device receives the weighed food part and transports the weighed food part to a sorting zone;
a computer adapted to receive the weight data associated with the food part; and
wherein the computer operably controls the weight sensing apparatus and the movement device, and is adapted to control transfer of the weighed food part from the weight sensing apparatus to the movement device, and control movement of the weighed food part from the movement device to a batch.

2. The apparatus of claim 1, further comprising:
wherein the computer is adapted to distribute the weighed food parts on the movement device; and
wherein the food parts are separated from food parts on the movement device between and including approximately 0.01 mm and 30 mm.

3. The apparatus of claim 1, further comprising:
a plurality of weight sensing apparatus adjacent the movement device; and
wherein the computer is adapted to control the plurality of weight sensing apparatuses to distribute the food parts on the movement device.

4. The apparatus of claim 1, further comprising:
a hopper for receiving the food part and transferring the food part;
wherein the computer operably controls the hopper; and
wherein the computer is adapted to transfer the food part from the hopper.

5. The apparatus of claim 4, wherein the hopper transfers the food part to the weight sensing apparatus.

6. The apparatus of claim 4, wherein the hopper transfer the food part to the movement device.

7. The apparatus of claim 1, further comprising:
an ejector for transferring the weighed food part from the movement device to a batch;
wherein the computer operably controls the ejector; and
wherein the computer is adapted to transfer the weighted food part from the movement device to the batch based on the food part weight data.

8. The apparatus of claim 7, further comprising:
a grading sensor generating grading data associated with the weighed food part;
wherein the computer is adapted to receive the grading data associated with the food part; and
wherein the computer is adapted to transfer the weighted food part from the movement device to the batch based on the food part grading data.

9. A method, comprising the steps of:
providing a static weight sensing apparatus;
providing a food part;
weighing the food part individually with the static weight sensing apparatus;
providing a movement device;
transferring the food part from the static weight sensing apparatus to the movement device;
providing a sorting device for transferring the food part from the movement device to a batch;
moving the food part from the weight sensing apparatus to the sorting device by the movement device; and
transferring the food part from the movement device to the batch.

10. The method of claim 9, further comprising the step of:
providing a computer; and
wherein the computer is adapted to operably control the weight sensing apparatus, transfer of the food part from the weight sensing apparatus to the movement device, movement of the movement device, and transfer of each food part from the movement device to the batch.

11. The method of claim 9, further comprising the step of providing a plurality of weight sensing apparatuses, wherein the weight sensing apparatuses transfer each food part from the weight sensing apparatus to the movement device spacing the food parts on the movement device.

12. The method of claim 9, further comprising the step of providing a hopper for receiving the food part and transferring the food part.

13. The method of claim 9, further comprising the steps of:
assigning each weight sensing apparatus with a food part criteria; and
associating use of each weight sensing apparatus with the food part criteria.

14. The method of claim 9, further comprising the step of transferring the food part to the weight sensing apparatus.

15. The method of claim 9, wherein the step of transferring the food part from the static weight sensing apparatus to the movement device includes the steps of:
transferring the food part from the static weight sensing apparatus to a hopper; and
transferring the food part from the hopper to the movement device.

16. The method of claim 9, further comprising the steps of:
generating weight data by the weight sensing apparatus, associating the weight data with each food part;
calculating the rate of transfer of each food part from the weight sensing apparatus to the movement device using the weight sensing data; and
adjusting the rate of transfer of each food part from the weight sensing apparatus to the movement device.

17. The method of claim 9, further comprising the steps of:
wherein the food part is associated with a minimum spacing between food parts;
wherein the weight sensing apparatus transfers the food part to the movement device; and
wherein the food part is separated from food parts on the movement device between and including approximately 0.01 mm and 30 mm.

18. The method of claim 9, further comprising the step of transferring a plurality of food parts to the movement device wherein the food parts accumulate in a single location on the movement device.

19. The method of claim 9, wherein the step of transferring the food part from the static weight sensing apparatus to the movement device includes the step of transferring the food part to a location on the movement device determined by a weight of the food part.

20. The method of claim 9, wherein the step of transferring the food part from the movement device to the batch includes the step of transferring the food part to the batch determined by a weight of the food part.
